(19) United States
(12) Patent Application Publication
(10) Pub. No.: US 2025/0020856 A1
(43) Pub. Date: Jan. 16, 2025

(54) OPTICAL MEMBER PRODUCTION METHOD

(71) Applicant: NITTO DENKO CORPORATION, Osaka (JP)

(72) Inventors: Kenjiro SAOMOTO, Osaka (JP); Naoyuki MATSUO, Osaka (JP); Shunya WAKAYAMA, Osaka (JP)

(73) Assignee: NITTO DENKO CORPORATION, Osaka (JP)

(21) Appl. No.: 18/714,691

(22) PCT Filed: Feb. 22, 2023
(86) PCT No.: PCT/JP2023/006441

§ 371 Date: May 30, 2024

(30) Foreign Application Priority Data
Mar. 31, 2022 (JP) 2022-058104

(51) Int. Cl. F21V 8/00

(52) U.S. Cl. CPC G02B 6/0065; G02B 6/0041

(57) ABSTRACT

Provided is an optical member production method including: a step A of preparing a porous layer supported on a substrate; a step B of applying laser light to the porous layer to remove a partial region of the porous layer, the partial region to be removed including a plurality of discrete island-like regions; and a step C of arranging a first adhesive layer on the porous layer after the step B.

### TECHNICAL FIELD

The present invention relates to an optical member production method.

### BACKGROUND ART

A method including utilizing a light-extracting layer having two regions different from each other in refractive index has been known as a method of taking light out of a light-guiding layer. Such light-extracting layer is disclosed in, for example, Patent Document No. 1.

In Patent Document No. 1, as an example of an approach to forming the light-extracting layer, there is a disclosure of a method including using an inkjet method. In the method, the pores of a porous layer are filled with ink (e.g., a pressure-sensitive adhesive turned into ink) in a predetermined pattern by the inkjet method, and hence a light-extracting layer in which a low-refractive index region where pores remain and a high-refractive index region whose pores are filled with the ink are arrayed in the predetermined pattern can be formed.

All the contents disclosed in Patent Document No. 1 are incorporated herein by reference. In this description, the light-extracting layer in Patent Document No. 1 may be referred to as “light-coupling layer.” In addition, the phrase “light is extracted” in Patent Document No. 1 may be referred to as “light is taken out” or “light is coupled.”

### CITATION LIST

### Patent Literature

Patent Document No. 1: WO 2019/182100 A1

### SUMMARY OF INVENTION

### Technical Problem

However, an investigation made by the inventors of the present invention has found that in a light-extracting layer formed by such a method including using an inkjet method as disclosed in Patent Document No. 1, an influence of scattered light (diffused light) from a region around its high-refractive index region may be large to make it impossible to obtain a desired light distribution characteristic. Specifically, the investigation has found that light having sufficiently high directivity cannot be taken out in some cases.

An object of an embodiment of the present invention is to provide a method by which an optical member including a light-extracting layer capable of taking out light having sufficiently high directivity can be produced.

### Solution to Problem

According to the embodiment of the present invention, there are provided solving means described in the following items.

### [Item 1]

An optical member production method including:
a step A of preparing a porous layer supported on a substrate;
a step B of applying laser light to the porous layer to remove a partial region of the porous layer, the partial region to be removed including a plurality of discrete island-like regions; and
a step C of arranging a first adhesive layer on the porous layer after the step B.

### [Item 2]

The optical member production method of Item 1, further including:
a step D of peeling the substrate from the porous layer after the step C; and
a step E of arranging a second adhesive layer on a side of the porous layer opposite to the first adhesive layer after the step D.

### [Item 3]

The optical member production method of Item 1 or 2, wherein an absorption coefficient of the substrate for the laser light is 500 cm-1 or more.

### [Item 4]

The optical member production method of any one of Items 1 to 3, wherein a light intensity distribution of the laser light is a top-hat type.

### [Item 5]

The optical member production method of any one of Items 1 to 4, wherein the laser light is UV laser light.

### [Item 6]

The optical member production method of Item 5, wherein an absorption coefficient of the substrate for the UV laser light is 1,000 cm-1 or more.

### [Item 7]

The optical member production method of any one of Items 1 to 6, wherein in the step A, the porous layer is formed on a peeling layer arranged on the substrate.

### [Item 8]

The optical member production method of Item 7, wherein the peeling layer contains, as a main component, a polymer free of a polar group.

### [Item 9]

The optical member production method of Item 7 or 8, wherein the peeling layer is formed from a cycloolefin-based polymer.

### [Item 10]

The optical member production method of Item 9, wherein the peeling layer has a thickness of 500 nm or less.

### Advantageous Effects of Invention

According to the embodiment of the present invention, the method by which the optical member including the light-extracting layer capable of taking out light having sufficiently high directivity can be produced is provided.

### BRIEF DESCRIPTION OF DRAWINGS

FIG. 1 is a sectional view for schematically illustrating an optical element 100 including an optical member 1 obtained by a production method according to an embodiment of the present invention.

FIG. 2 is a plan view for illustrating an example of the arrangement of a first region 12 and a second region 14 in a first layer 10 of the optical member 1 (the optical element 100).

FIG. 3 is a sectional view for schematically illustrating another optical element 200 including the optical member obtained by the production method according to the embodiment of the present invention.

FIG. 4A is a sectional view for schematically illustrating one step of the production method according to the embodiment of the present invention.

FIG. 4B is a sectional view for schematically illustrating one step of the production method according to the embodiment of the present invention.

FIG. 4C is a sectional view for schematically illustrating one step of the production method according to the embodiment of the present invention.

FIG. 4D is a sectional view for schematically illustrating one step of the production method according to the embodiment of the present invention.

FIG. 4E is a sectional view for schematically illustrating one step of the production method according to the embodiment of the present invention.

FIG. 4F is a sectional view for schematically illustrating one step of the production method according to the embodiment of the present invention.

FIG. 5A is a plan view for schematically illustrating a shaping film 72.

FIG. 5B is a sectional view for schematically illustrating the shaping film 72, the sectional view being an illustration of a section along the line 5B-5B′ of FIG. 5A.

FIG. 6 is a sectional view for schematically illustrating an optical member 801 of Reference Example.

FIG. 7 is a view for describing a method of producing the optical member 801.

FIG. 8 is a sectional view for schematically illustrating an optical element 800 including the optical member 801.

FIG. 9 is a sectional view for schematically illustrating an optical member 901 of Comparative Example.

FIG. 10A is a view for describing a method of producing the optical member 901.

FIG. 10B is a view for describing the method of producing the optical member 901.

FIG. 10C is a view for describing the method of producing the optical member 901.

FIG. 11 is a sectional view for schematically illustrating an optical element 900 including the optical member 901.

FIG. 12 is an optical microscope image of the optical member 901 of Comparative Example.

FIG. 13 is an optical microscope image of the optical member of Example 1.

FIG. 14 is an optical microscope image of an optical member in which the fracture of a porous layer 10P occurs.

FIG. 15 is an optical microscope image of the optical member in which the fracture of the porous layer 10P does not occur.

FIG. 16 is a view for illustrating a manner in which part of the porous layer 10P is peeled by the application of laser light LB together with a peeling layer 2, the view being an illustration of a case in which the peeling layer 2 is relatively thick.

FIG. 17 is a view for illustrating a manner in which part of the porous layer 10P is peeled by the application of the laser light LB together with the peeling layer 2, the view being an illustration of a case in which the peeling layer 2 is relatively thin.

### DESCRIPTION OF EMBODIMENTS

Now, an optical member production method according to an embodiment of the present invention is described with reference to the drawings. Embodiments of the present invention are not limited to those exemplified in the following description.

### [Configuration of Optical Member]

Prior to the description of the production method according to the embodiment of the present invention, the configuration of an optical member produced by using the production method according to the embodiment of the present invention is described. For example, the optical member to be described below can take light propagating in a light-guiding layer out of the main surface of the light-guiding layer, or guide the light to an optical member arranged in contact with the main surface of the light-guiding layer. The guiding of the light propagating in the light-guiding layer to the optical member arranged in contact with the main surface of the light-guiding layer is referred to as “to optically couple,” and a layer that acts in this way is referred to as “light-coupling layer.” The optical member to be described below is suitably used as, for example, the light-coupling layer of a light-guiding member described in WO 2022/025067 A1. As described in WO 2022/025067 A1, the light-coupling layer may be arranged between the light-guiding layer and a direction-changing layer. The direction-changing layer has, for example, a plurality of internal spaces for forming an interface that directs the light toward the main surface side of the direction-changing layer through total internal reflection. The direction-changing layer having such internal spaces may be, for example, a light-distributing structural body disclosed in WO 2019/087118 A1. In addition, the direction-changing layer may be a publicly-known prism sheet. All the contents disclosed in WO 2022/025067 A1 and WO 2019/087118 A1 are incorporated herein by reference.

FIG. 1 is a sectional view for schematically illustrating an optical element 100 including an optical member 1. As illustrated in FIG. 1, the optical element 100 includes the optical member 1 and a light-guiding layer 50.

The optical member 1 includes: a first layer 10; a second layer 20 and a third layer 30 facing each other across the first layer 10; and a substrate layer 40 supporting the first layer 10, the second layer 20 and the third layer 30.

The second layer 20 and the third layer 30 are each adjacent to the first layer 10 in a layer normal direction, and the third layer 30 is positioned on a side opposite to the second layer 20 with respect to the first layer 10. The second layer 20 and the third layer 30 are each an adhesive layer having an adhesive property. In the following description, the second layer 20 may be referred to as “first adhesive layer,” and the third layer 30 may be referred to as “second adhesive layer.” In the illustrated example, the first adhesive layer 20 is arranged between the first layer 10 and the light-guiding layer 50, and the second adhesive layer 30 is arranged between the first layer 10 and the substrate layer 40.

The first layer 10 includes a first region 12 having a porous structure and a second region 14 free of a porous structure. The second region 14 is filled with an adhesive. More specifically, the second region 14 contains the same material as that of the first adhesive layer 20 and/or the same material as that of the second adhesive layer 30. In addition, the second region 14 includes a plurality of island-like regions that are discretely arranged.

When the refractive index of the first region 12 is represented by n₁, the refractive index of the second region 14 is represented by n₂, and the refractive index of the second layer (first adhesive layer) 20 is represented by n₃, n₁<n₂ and n₁<n₃. The refractive index mi of the first region 12 is, for example, 1.30 or less. The refractive index n₂ of the second region 14 and the refractive index n₃ of the first adhesive layer 20 are each, for example, 1.43 or more. In addition, when the refractive index of the third layer (second adhesive layer) 30 is represented by n₄, n₁<n₄. The refractive index n₂ of the second region 14, the refractive index n₃ of the first adhesive layer 20 and the refractive index n₄ of the second adhesive layer 30 may be substantially identical to each other.

The first region 12 having a porous structure may be formed from, for example, a silica porous body. The porosity of the silica porous body is more than 0% and less than 100%. To obtain a low refractive index, the porosity of the silica porous body is preferably 40% or more, more preferably 50% or more, still more preferably 55% or more. Although the upper limit of the porosity is not particularly limited, the upper limit is preferably 95% or less, more preferably 85% or less from the viewpoint of strength. The refractive index of silica (the matrix portion of the silica porous body) is, for example, 1.41 or more and 1.43 or less.

In the description of the present application, the term “adhesive” is used in a meaning including a pressure-sensitive adhesive (also referred to as “tackiness agent”). Specific examples of the adhesive for forming each of the second region 14, the first adhesive layer 20 and the second adhesive layer 30 include a rubber-based adhesive, an acrylic adhesive, a silicone-based adhesive, an epoxy-based adhesive, a cellulose-based adhesive and a polyester-based adhesive. Those adhesives may be used alone or in combination thereof.

When the first region 12 and the second region 14 are arranged in a predetermined pattern, the first layer 10 that functions as a light-coupling layer (light-extracting layer) is obtained. The light-coupling layer is arranged between two optical layers, for example, between a light-guiding layer and a direction-changing layer to guide part of light propagating in the light-guiding layer to the direction-changing layer. The direction-changing layer has, for example, an interface (or a surface) that gives the propagating light a component in a layer normal direction. The direction-changing layer may be, for example, a prism sheet.

The optical element 100 having the above-mentioned configuration functions as described below.

An X-direction, a Y-direction and a Z-direction perpendicular to each other are illustrated in FIG. 1. Herein, each layer of the optical element 100 has a main surface parallel to an XY plane. Light emitted from a light source LS toward the light-receiving end surface (not shown) of the light-guiding layer 50 propagates in the light-guiding layer 50 in the Y-direction (guided light Lp). Part of the light that has entered the light-guiding layer 50 is optically coupled (taken out) to the substrate layer 40 by the first layer 10, the second layer 20 and the third layer 30, and is emitted in the Z-direction (emitted light LB). Of course, the direction in which the light propagates has a variation (distribution) from the Y-direction, and the direction in which the light is emitted also has a variation (distribution) from the Z-direction.

Of the light Lp propagating in the light-guiding layer 50, the light that has entered an interface between the second layer 20 and the first region 12 of the first layer 10 is subjected to total internal reflection. In contrast, the light that has entered an interface between the second layer 20 and the second region 14 of the first layer 10 passes through the second region 14 of the first layer 10, the third layer 30 and the substrate layer 40 without being subjected to total internal reflection, and is emitted from the optical element 100.

When the arrangement of the first region 12 and second region 14 of the first layer 10 in the surface (surface parallel to the XY plane) of the layer is adjusted, the light distribution profile (e.g., emission intensity distribution or emission angle distribution) of the light taken out of the light-guiding layer 50 (coupled to the substrate layer 40) by the optical member 1 can be controlled. The arrangement of the first region 12 and the second region 14 in the first layer 10 is appropriately set in accordance with a required light distribution profile.

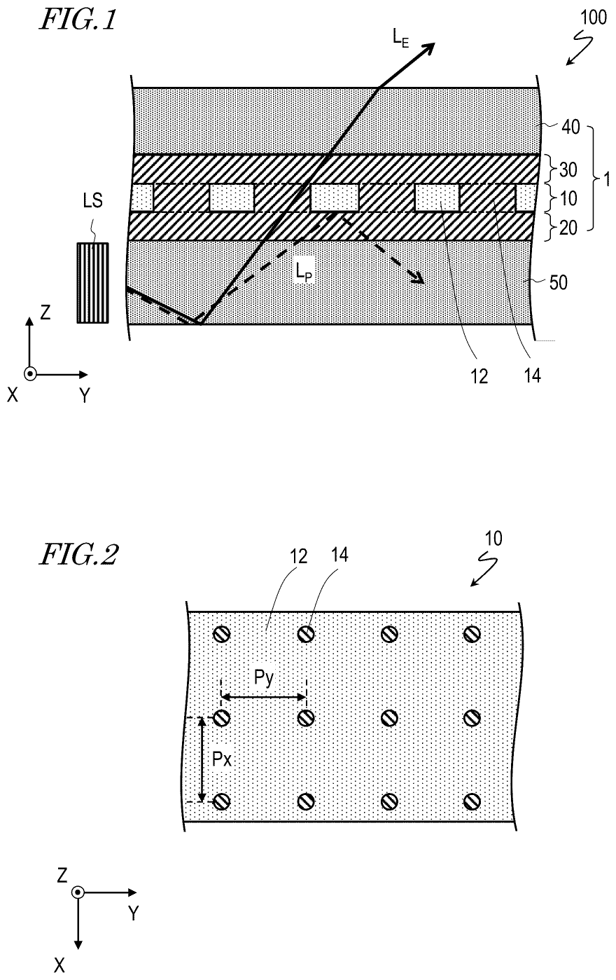

FIG. 2 is a view for illustrating an example of the arrangement of the first region 12 and the second region 14 in the first layer 10. In the example illustrated in FIG. 2, in the first layer 10, the plurality of second regions 14 each having a circular shape are discretely arranged. The second regions 14 each have a diameter of, for example, about 1 μm or more and about 1,000 μm or less. In addition, a pitch Px between the second regions 14 adjacent to each other in the X-direction and a pitch Py between the second regions 14 adjacent to each other in the Y-direction are each independently, for example, about 2 μm or more and about 5,000 μm or less. The pitches Px and Py are distances between the centers (area centroids) of the second regions 14 adjacent to each other in the X-direction and the Y-direction, respectively.

The arrangement of the first region 12 and the second region 14 in the first layer 10 may be variously modified. In addition, the shape of the second region 14 is not limited to a circular shape given as an example thereof, and may be any one of various shapes.

The shapes and dimensions of the second regions 14, the density thereof in the surface of the first layer 10 and the occupancy thereof in the first layer 10 may be appropriately changed in accordance with purposes for, and applications in, which the optical member 1 (the optical element 100) is used. For example, when satisfactory visibility such as transparency is required, the long diameter of each of the second regions 14 is preferably 100 μm or less, more preferably 70 μm or less. For example, when the second regions 14 are each a circular shape as illustrated in FIG. 2, the diameter of the circle is preferably 100 μm or less. When the long diameter of each of the second regions 14 is 100 μm or less, the second regions 14 can be suppressed from being viewed in an application where an instrument including the optical member 1 is observed from a relatively short distance, such as a mobile display or small signage. When each of the second regions 14 is not a circular shape, the dimensions of the second regions 14 may be evaluated by, for example, an isoperimetric circle-equivalent diameter.

The optical member produced by the production method according to the embodiment of the present invention (and an optical element including the member) each only need to include at least the above-mentioned first layer 10, and may be variously modified.

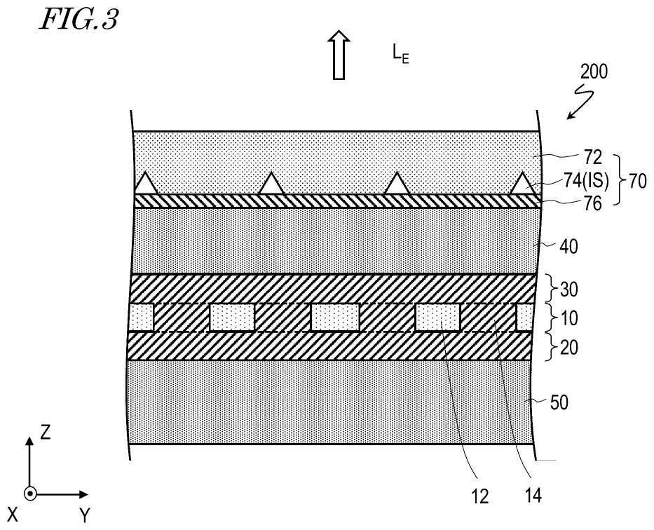

Another optical element 200 including the optical member produced by the production method according to the embodiment of the present invention is illustrated in FIG. 3. The optical element 200 illustrated in FIG. 3 is different from the optical element 100 illustrated in FIG. 1 in that the former element further has a light distribution-controlling structure having a plurality of internal spaces IS.

In the illustrated example, the light distribution-controlling structure having the plurality of internal spaces IS is formed in a direction-changing layer 70 arranged on the substrate layer 40. The direction-changing layer 70 includes: a shaping film 72 having a main surface having a plurality of recesses 74; and an adhesive layer 76 arranged between the shaping film 72 and the substrate layer 40. The plurality of internal spaces IS of the light distribution-controlling structure are defined by the plurality of recesses 74 of the shaping film 72 and the adhesive layer 76, and form an interface that directs part of light propagating in the substrate layer 40 toward the light emission surface side of the optical element through total internal reflection (TIR). [Optical Member Production Method]

A method of producing the optical member 1 according to an embodiment of the present invention is described.

The production method according to the embodiment of the present invention includes: a step A of preparing a porous layer supported on a substrate; a step B of applying laser light to the porous layer to remove a partial region of the porous layer, the partial region to be removed including a plurality of discrete island-like regions; and a step C of arranging a first adhesive layer on the porous layer after the step B. According to the production method according to the embodiment of the present invention, as described later, an optical member including a light-coupling layer (light-extracting layer) capable of taking out light having sufficiently high directivity can be produced.

The production method according to the embodiment of the present invention may further include: a step D of peeling the substrate from the porous layer after the step C; and a step E of arranging a second adhesive layer on a side of the porous layer opposite to the first adhesive layer after the step D.

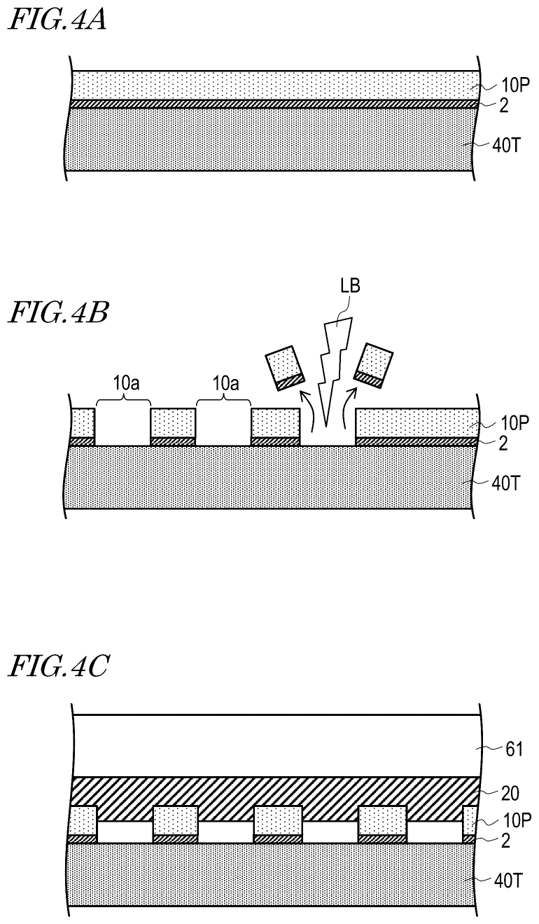

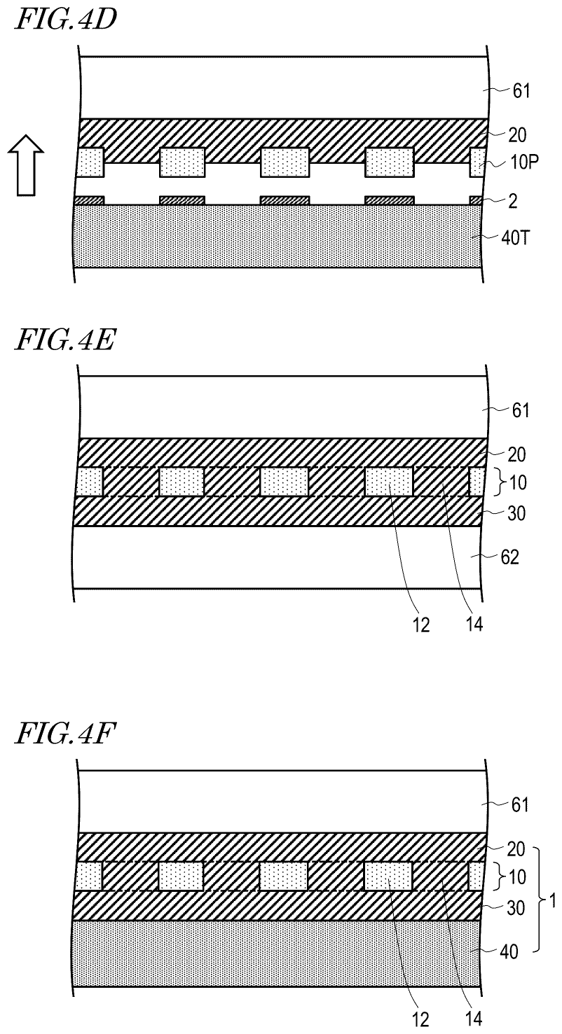

A specific example of the production method according to the embodiment of the present invention is described with reference to FIG. 4A to FIG. 4F.

First, as illustrated in FIG. 4A, a layer (porous layer) 10P having a porous structure, the layer being supported on a substrate 40T, is prepared. For example, the porous layer 10P is formed on the substrate 40T. The substrate 40T may be a film formed from a resin. For example, a polyimide (PI) film or a black polyethylene terephthalate (PET) film may be used as the substrate 40T. The porous layer 10P may be formed by, for example, a method to be described later.

In the illustrated example, a peeling layer 2 is arranged on the substrate 40T, and the porous layer 10P is formed on the peeling layer 2. The peeling layer 2 is formed from a material (e.g., a cycloolefin polymer) having high peelability with respect to the porous layer 10P. Laser light absorbability may be imparted to the peeling layer 2. The peeling layer 2 may be omitted. The arrangement of the peeling layer 2 can further facilitate the transfer (a step illustrated in FIG. 4E) of the porous layer 10P to be described later (i.e., improve the peelability of the porous layer 10P).

The thickness of the peeling layer 2 is, for example, 1,000 nm or less. However, when the peeling layer 2 is relatively thick, the fracture of the porous layer 10P may occur in a step of applying laser light to the porous layer 10P to be performed later. From the viewpoint of suppressing the fracture of the porous layer 10P, the thickness of the peeling layer 2 is preferably 500 nm or less, more preferably 250 nm or less, still more preferably 200 nm or less. When the material (e.g., polyimide) from which the porous layer 10P easily peels is used as a material for the substrate 40T, the peeling layer 2 may be omitted.

The peeling layer 2 preferably contains, as a main component, a polymer free of a polar group (hereinafter also referred to as “nonpolar polymer”). The phrase “free of a polar group” means that no polar group is present in a main chain skeleton excluding a main chain terminal of the polymer and a side chain skeleton. A polar group derived from an initiator or a quencher may be present in the main chain terminal of the polymer. In addition, the phrase “contains, as a main component, a polymer free of a polar group” means that the content of the nonpolar polymer in the peeling layer 2 is 50 mass % or more. The content of the nonpolar polymer in the peeling layer 2 is preferably 80 mass % or more. Examples of the nonpolar polymer include a polyolefin-based polymer, a cycloolefin-based polymer such as a polynorbornene-based polymer and a polystyrene-based polymer. Of those, a cycloolefin-based polymer and a polyolefin-based polymer are preferred, and a cycloolefin-based polymer is particularly preferred.

Next, as illustrated in FIG. 4B, laser light LB is applied to the porous layer 10P to remove (peel) the partial region of the porous layer 10P. In other words, in the step, the porous layer 10P is partially removed by a laser lift-off method. At this time, the partial region to be removed includes a plurality of discrete island-like regions 10a.

UV laser light may be suitably used as the laser light LB. Although laser light except the UV laser light (e.g., infrared laser light) may be used, the use of the UV laser light enables suitable performance of the removal of the porous layer 10P even in a fine pattern. The wavelength of the UV laser light falls within the range of preferably from 150 nm or more to 380 nm or less, more preferably from 190 nm or more to 360 nm or less. For example, an ArF excimer laser light source, a KrF excimer laser light source, a XeCl excimer laser light source and a XeF excimer laser light source provide laser light beams having wavelengths of 193 nm, 248 nm, 308 nm and 351 nm, respectively.

A light irradiation amount required for the removal of the porous layer 10P may be appropriately set by regulating, for example, the intensity and irradiation time of the light to be applied. In addition, when the absorption coefficient of the substrate 40T is appropriately set in accordance with the wavelength range of the laser light LB to be used, the removal of the porous layer 10P can be suitably performed. Specifically, the absorption coefficient of the substrate 40T for the laser light LB to be used is preferably 500 cm-1 or more. For example, when UV laser light having a wavelength of 355 nm is used as the laser light LB, the absorption coefficient of the substrate 40T for the light having a wavelength of 355 nm is preferably 500 cm-1 or more. When the thickness of the substrate 40T is represented by L, a light intensity obtained by subtracting the intensity of reflected light from the intensity of incident light is represented by I₀, and the intensity of the light after its passage through the substrate 40T is represented by I, the absorption coefficient α of the substrate satisfies the relationship of −αL=log₁₀ (I/I₀) (derived from the Lambert-Beer equation).

When the UV laser light is used, the absorption coefficient of the substrate 40T for the UV laser light is more preferably 1,000 cm⁻¹ or more from the viewpoint of improving processing efficiency and productivity. For example, polyethylene naphthalate (PEN) or polyimide may be suitably used as a material for such substrate 40T. Polyethylene naphthalate may be particularly suitably used from the viewpoint of cost.

The light intensity distribution of the laser light (beam) LB is, for example, a Gaussian type or a top-hat type. When the light intensity distribution of the laser light LB is a top-hat type, energy provided by the application of the laser light LB is easily uniformized in an irradiation region.

The beam shape of the laser light may be a circular shape or a rectangular shape. The light may be condensed with a condensing optical system such as an objective lens. When the beam shape is a circular shape, for example, the focal diameter (spot diameter) of the light preferably falls within the range of from 1 μm or more to 200 μm or less, and more preferably falls within the range of from 20 μm or more to 120 μm or less.

From the viewpoint of performing pattern formation in a short time period, a pulse laser is preferably used, and a laser having a pulse width of the order of from nanoseconds to microseconds is preferably used. Although the repetition frequency of pulse laser light is not particularly limited, the frequency is preferably as high as possible from the viewpoint of productivity, and may be appropriately adjusted within the range of from 10 kHz to 5,000 KHz.

As the kind of a laser oscillator that satisfies the above-mentioned various requirements, there are given, for example, a YAG laser, a YLF laser, a YVO₄ laser, a fiber laser and a semiconductor laser, in addition to an excimer laser.

Although conditions for the application of the laser light LB may be set to any appropriate conditions, the energy density of the light is preferably, for example, 0.1 J/cm² or more and 5 J/cm² or less.

From the viewpoint of performing desired pattern processing at a high speed, a galvano scanner or a polygon scanner, or a scanner unit obtained by combining the scanners is preferably used. The use of such scanner unit enables pattern formation in the scanning direction of the laser light at a scan rate in the range of from 0.01 m/s to 170 m/s. A pattern pitch may be appropriately set by adjusting the repetition frequency of a laser pulse in accordance with the scan rate, and may be set within the range of, for example, from 10 μm to 500 μm.

A pattern pitch in a direction perpendicular to the scanning direction may be appropriately adjusted by controlling a relative positional relationship between the scanner unit and an irradiation target. In such control, a pattern can be formed at a desired pitch as follows: a precision stage having a drive shaft is used; for example, a sheet-shaped irradiation target is adsorbed by, and fixed to, the surface of the stage; and the target is irradiated with the laser light while being fed in the direction perpendicular to the scanning direction at constant intervals. Alternatively, pattern formation may be performed with the scanner unit while a long original fabric that has been wound around is intermittently or continuously conveyed by a roll-to-roll conveyance system.

Subsequently, as illustrated in FIG. 4C, the first adhesive layer 20 is arranged on the porous layer 10P. Specifically, the first adhesive layer 20 formed on a peeling sheet 61 is bonded onto the porous layer 10P.

Next, as illustrated in FIG. 4D, the substrate 40T is peeled from the porous layer 10P. In the illustrated example, the peeling layer 2 is formed on the substrate 40T, and hence the substrate 40T is peeled from the porous layer 10P together with the peeling layer 2.

Subsequently, as illustrated in FIG. 4E, the second adhesive layer 30 is arranged on the side of the porous layer 10P opposite to the first adhesive layer 20. Specifically, the second adhesive layer 30 formed on a peeling sheet 62 is bonded onto the first layer 10. At this time, a region where the porous layer 10P remains serves as the first region 12. In addition, when the adhesive enters the plurality of island-like regions 10a from each of which the porous layer 10P has been removed from the first adhesive layer 20 in the step illustrated in FIG. 4C, and/or the adhesive enters the regions from the second adhesive layer 30 in the step illustrated in FIG. 4E, the island-like regions 10a each serve as the second region 14. Thus, the first layer 10 including the first region 12 and the second region 14 is obtained. A barrier layer for suppressing the permeation of an adhesive component into the porous layer 10P may be present between the porous layer 10P and the first adhesive layer 20, and/or between the porous layer 10P and the second adhesive layer 30.

Next, as illustrated in FIG. 4F, the peeling sheet 62 is peeled, and the substrate layer 40 is bonded to the second adhesive layer 30. Thus, the optical member 1 is obtained. In addition, after that, the peeling sheet 61 is peeled, and the light-guiding layer 50 is bonded to the first adhesive layer 20. Thus, the optical element 100 is obtained.

Herein, an example in which the substrate 40T is peeled from the porous layer 10P (in other words, the porous layer 10P is transferred from the substrate 40T onto the laminate of the peeling sheet 61 and the first adhesive layer 20) has been described. However, the following case is permitted: the substrate 40T is not peeled from the porous layer 10P (in other words, the substrate 40T is not caused to function as a transfer substrate), and the substrate 40T functions as part of the optical member (optical element). In that case, in the step illustrated in FIG. 4C, the plurality of island-like regions 10a may be completely filled with the adhesive entering from the first adhesive layer 20. In addition, when the substrate 40T is not peeled from the porous layer 10P, the second adhesive layer 30 may be laminated on the side of the substrate 40T opposite to the porous layer 10P. In the case where the production method according to the embodiment of the present invention includes the step D of peeling the substrate 40T from the porous layer 10P, the thickness of the optical member (optical element) can be reduced by an amount corresponding to the removal of the substrate 40T as compared to that in the case where the substrate 40T is not peeled from the porous layer 10P.

According to the above-mentioned production method (including at least the steps A, B and C), an optical member including a light-coupling layer (light-extracting layer) capable of taking out light having sufficiently high directivity can be produced. The result of the verification of the foregoing is described below by way of Examples 1 to 6, Reference Example and Comparative Example.

### EXAMPLE 1

### (1) Preparation of Substrate and Formation of Peeling Layer

A black PET film having a thickness of 50 μm (LUMIRROR X30 manufactured by Toray Industries, Inc.) was prepared as the substrate 40T, and the peeling layer 2 was formed thereon as described below.

A coating liquid for forming the peeling layer 2 (coating liquid for forming a peeling layer) was prepared by: loading a cycloolefin polymer (COP) (ZEONEX F52R manufactured by Zeon Corporation) into ethylcyclohexane so that its concentration became 8 mass %; and stirring and mixing the materials under normal temperature with a stirrer until the dissolution of the COP was visually observed. In addition, one surface of the black PET film was subjected to corona treatment (discharge degree: 0.22 W/cm²) for the purpose of suppressing the repelling of the coating liquid for forming a peeling layer. The coating liquid for forming a peeling layer was applied to the surface of the black PET film subjected to the corona treatment, and was then dried at 120° C. for 3 minutes to form the peeling layer 2 having a thickness of 230 nm. The thickness of the peeling layer 2 was measured with a microscopic spectral thickness meter (the same holds true for any other example).

### (2) Formation of Porous Layer

A coating liquid for forming the porous layer 10P (the first region 12 of the first layer 10) was prepared as described below.

### (2-1) Gelation of Silicon Compound

0.95 Gram of methyltrimethoxysilane (MTMS) serving as a precursor of a gel-like silicon compound was dissolved in 2.2 g of dimethyl sulfoxide (DMSO) to prepare a mixed liquid A. 0.5 Gram of a 0.01 mol/L aqueous solution of oxalic acid was added to the mixed liquid A, and the mixture was stirred at room temperature for 30 minutes so that MTMS was hydrolyzed. Thus, a mixed liquid B containing tris(hydroxy)methylsilane was produced.

0.38 Gram of 28 mass % ammonia water and 0.2 g of pure water were added to 5.5 g of DMSO. After that, the above-mentioned mixed liquid B was further added to the mixture, and the whole was stirred at room temperature for 15 minutes so that the gelation of tris(hydroxy)methylsilane was performed. Thus, a mixed liquid C containing a gel-like silicon compound (polymethylsilsesquioxane) was obtained.

### (2-2) Aging Treatment

The mixed liquid C containing the gel-like silicon compound prepared as described above was subjected to aging treatment by being incubated as it was at 40° C. for 20 hours.

### (2-3) Pulverization Treatment

Next, the gel-like silicon compound subjected to the aging treatment as described above was crushed into granular shapes each having a size of from several millimeters to several centimeters with a spatula. Next, 40 g of isopropyl alcohol (IPA) was added to the mixed liquid C, and the mixture was lightly stirred. After that, the mixture was left at rest at room temperature for 6 hours so that the solvent and a catalyst in the gel were decanted. The same decantation treatment was performed three times to replace the solvent with a new one. Thus, a mixed liquid D was obtained. Next, the gel-like silicon compound in the mixed liquid D was subjected to pulverization treatment (high-pressure media-less pulverization). The pulverization treatment (high-pressure media-less pulverization) was performed as follows: 1.85 g of the gel-like silicon compound in the mixed liquid D and 1.15 g of IPA were weighed in a 5-cubic centimeter screw bottle, and were then pulverized with a homogenizer (manufactured by SMT Co., Ltd.: product name: UH-50) under the conditions of 50 W and 20 kHz for 2 minutes.

The pulverization treatment pulverized the gel-like silicon compound in the above-mentioned mixed liquid D, and hence the mixed liquid D′ became a sol liquid of the pulverized products. A volume-average particle diameter representing a variation in particle size between the pulverized products in the mixed liquid D′ was determined with a dynamic light scattering nanotrac particle size analyzer (Model UPA-EX150 manufactured by Nikkiso Co., Ltd.). As a result, the volume-average particle diameter was from 0.50 to 0.70. Further, a methyl ethyl ketone (MEK) solution containing a photobase generator (Wako Pure Chemical Industries, Ltd.: product name: WPBG-266) at a concentration of 1.5 mass % and a MEK solution containing bis(trimethoxysilyl) ethane at a concentration of 5 mass % were added at a ratio of 0.062 g: 0.036 g to 0.75 g of the sol liquid (mixed liquid C′) to provide a coating liquid for forming a porous layer. The coating liquid for forming a porous layer contains a silica porous body including a silsesquioxane as a basic structure.

The coating liquid for forming a porous layer was applied onto the peeling layer 2 so that the thickness of a coating film after its drying became 700 nm. Thus, a coating film was formed. The coating film was left at rest for 1 minute, and was then dried at 100° C. for 2 minutes. The coating film after the drying was irradiated with UV light having a wavelength of 360 nm in a light irradiation amount (energy) of 300 mJ/cm². Thus, a laminate in which the peeling layer 2 and the porous layer 10P (silica porous body obtained by chemical bonding between silica microporous particles) were formed on the black PET film was obtained. The refractive index of the porous layer 10P was 1.15.

### (3) Partial Removal of Porous Layer by Laser Lift-off Method

UV laser light was applied to the resultant laminate under the following various conditions to remove the partial region (plurality of island-like regions) of the porous layer 10P.

Laser oscillator: Talon 355-20 manufactured by Spectra-Physics, Inc.

Wavelength: 355 nm

Scanner: intelliSCAN 14 (galvano scanner) manufactured by SCANLAB GmbH

Beam intensity distribution: Gaussian

Focal spot size: @80 μm

Repetition frequency: 12.5 kHz

Pattern pitch: 200 μm

Pattern processing area: 0100 mm

Scan rate: 2.5 m/s

Power: 0.913 W

Pulse energy: 73 μJ

(4) Production of Optical Element

An optical element having the same configuration as that of the optical element 200 illustrated in FIG. 3 was produced by using the laminate from which the porous layer 10P had been partially removed as described above. The second layer (first adhesive layer) 20 and the third layer (second adhesive layer) 30 were each formed by using an acrylic adhesive so as to have a thickness of 10 μm. A film formed from an acrylic resin was used as the substrate layer 40, and an adhesive layer (adhesive layer for bonding the substrate layer 40 and the shaping film 72) 76 for forming the direction-changing layer 70 was formed by using a polyester-based adhesive.

The second region 14 of the first layer 10 was a substantially circular shape (diameter: about 93 μm). An area ratio (designed value) occupied by the second region 14 in the first layer 10 was 17.0%.

An uneven shaping film was produced as the shaping film 72 in accordance with a method described in Japanese Patent Translation Publication No. 2013-524288. Specifically, the surface of a polymethyl methacrylate (PMMA) film was coated with lacquer (FINECURE RM-64 manufactured by Sanyo Chemical Industries, Ltd.), and an optical pattern was embossed on the film surface including the lacquer, followed by the curing of the lacquer. Thus, the uneven shaping film was produced. The uneven shaping film had a total thickness of 130 μm and a haze value of 0.8%.

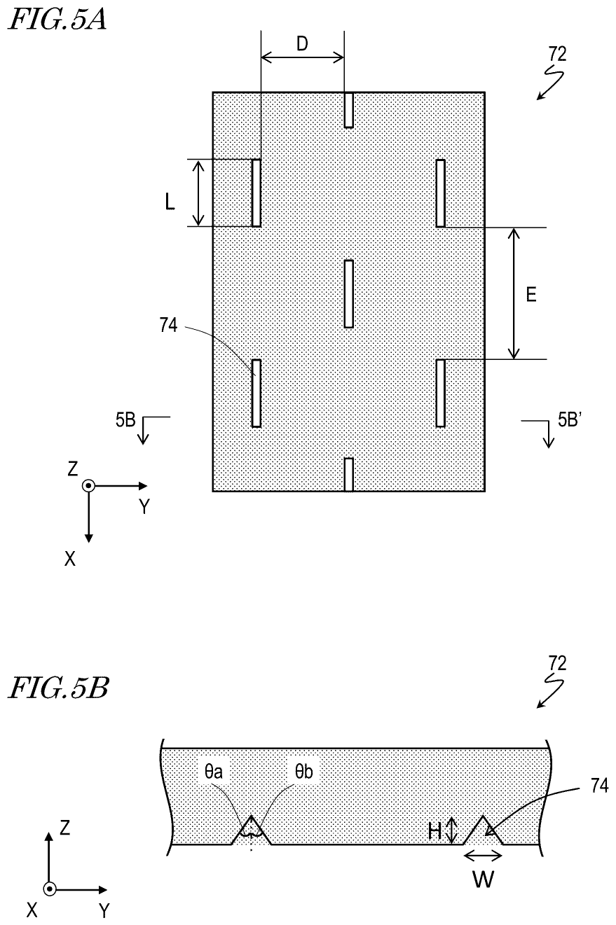

Part of the produced uneven shaping film 72 is illustrated in each of FIG. 5A and FIG. 5B. FIG. 5A is a plan view when the uneven shaping film 72 is viewed from its main surface (uneven surface) side having the plurality of recesses 74, and FIG. 5B is a sectional view along the line 5B-5B′ in FIG. 5A. The arrangement interval E of the plurality of recesses 74 in an X-direction was 155 μm, and the arrangement interval D thereof in a Y-direction was 100 μm. A section of each of the recesses 74 was a triangular shape, and the recesses 74 each had a length L of 80 μm, a width W of 14 μm and a depth H of 10 μm. The density of the recesses 74 in the surface of the uneven shaping film 72 was 3,612 portions/cm². Angles θa and θb in FIG. 5B were each 41°, and the occupied area ratio of the recesses 74 when the uneven shaping film 72 was viewed in plan view from the uneven surface side was 4.05%.

### EXAMPLE 2

A PI film having a thickness of 50 μm (KAPTON H200 manufactured by Du Pont-Toray Co., Ltd.) was prepared as the substrate 40T, and the porous layer 10P was formed thereon in the same manner as in Example 1 without formation of the peeling layer 2. UV laser light was applied to the resultant laminate under the following various conditions to remove the partial region (plurality of island-like regions) of the porous layer 10P.

Laser oscillator: Talon 355-20 manufactured by Spectra-Physics, Inc.

Wavelength: 355 nm

Scanner: intelliSCAN 14 (galvano scanner) manufactured by SCANLAB GmbH

Beam intensity distribution: Gaussian

Focal spot size: @80 μm

Repetition frequency: 12.5 kHz

Pattern pitch: 200 μm

Pattern processing area: 0100 mm

Scan rate: 2.5 m/s

Power: 0.375 W

Pulse energy: 30 μJ

An optical element was produced in the same manner as in Example 1 by using the laminate from which the porous layer 10P had been partially removed as described above. The second region 14 of the first layer 10 was a substantially circular shape (diameter: about 82 μm). An area ratio (designed value) occupied by the second region 14 in the first layer 10 was 13.2%.

### EXAMPLE 3

A laminate in which the peeling layer 2 and the porous layer 10P were formed on the substrate 40T was obtained in the same manner as in Example 1. UV laser light was applied to the resultant laminate under the following various conditions to remove the partial region (plurality of island-like regions) of the porous layer 10P.

Laser oscillator: Talon 355-20 manufactured by Spectra-Physics, Inc.

Wavelength: 355 nm

Scanner: LSE310 (polygon scanner) manufactured by Next Scan Technology BVBA

Beam intensity distribution: Gaussian

Focal spot size: φ80μ m

Repetition frequency: 200 kHz

Pattern pitch: 200 μm

Pattern processing area: 0100 mm

Scan rate: 40 m/s

Power: 14.6 W

Pulse energy: 73 μJ

An optical element was produced in the same manner as in Example 1 by using the laminate from which the porous layer 10P had been partially removed as described above. The second region 14 of the first layer 10 was a substantially circular shape (diameter: about 90 μm). An area ratio (designed value) occupied by the second region 14 in the first layer 10 was 15.9%.

### EXAMPLE 4

A laminate in which the peeling layer 2 and the porous layer 10P were formed on the substrate 40T was obtained in the same manner as in Example 1. Infrared laser light was applied to the resultant laminate under the following various conditions to remove the partial region (plurality of island-like regions) of the porous layer 10P.

Laser oscillator: redENERGY G4 manufactured by SPI Lasers Limited

Wavelength: 1,060 nm

Scanner: LSE310 (polygon scanner) manufactured by Next Scan Technology BVBA

Beam intensity distribution: Gaussian

Focal spot size: ¢80 μm

Repetition frequency: 500 kHz

Pattern pitch: 200 μm

Pattern processing area: 0100 mm

Scan rate: 100 m/s

Power: 55 W

Pulse energy: 110 μJ

An optical element was produced in the same manner as in Example 1 by using the laminate from which the porous layer 10P had been partially removed as described above. The second region 14 of the first layer 10 was a substantially circular shape (diameter: about 102 μm). An area ratio (designed value) occupied by the second region 14 in the first layer 10 was 20.4%.

### EXAMPLE 5

A laminate in which the peeling layer 2 and the porous layer 10P were formed on the substrate 40T was obtained in the same manner as in Example 1. UV laser light was applied to the resultant laminate under the same conditions as those in Example 1 to remove the partial region (plurality of island-like regions) of the porous layer 10P.

An optical element was produced in substantially the same manner as in Example 1 by using the laminate from which the porous layer 10P had been partially removed as described above. However, the thickness of each of the second layer (first adhesive layer) 20 and the third layer (second adhesive layer) 30 was set to 17 μm. The second region 14 of the first layer 10 was a substantially circular shape (diameter: about 95 μm). An area ratio (designed value) occupied by the second region 14 in the first layer 10 was 17.7%.

### EXAMPLE 6

An acrylic resin film having a thickness of 30 μm was prepared as the substrate 40T, and the porous layer 10P was formed thereon in the same manner as in Example 2. UV laser light was applied to the resultant laminate under the following various conditions to remove the partial region (plurality of island-like regions) of the porous layer 10P.

Laser oscillator: Excimer laser manufactured by MLase GmbH.

Wavelength: 193 nm

Scanner: Control the XY stage while the laser is fixed

Beam intensity distribution: Top-hat

Focal spot size: ¢100 μm

Repetition frequency: 0.1 kHz

Pattern pitch: 150 μm

Pattern processing area: 0100 mm

Scan rate: 0.015 m/s

Power: 0.001 W

Pulse energy: 12μJ

An optical element was produced in substantially the same manner as in Example 1 by using the laminate from which the porous layer 10P had been partially removed as described above. However, the substrate 40T was not peeled from the porous layer 10P, and the substrate 40T was used as the substrate layer 40. The optical element has a shape from which the third layer (second adhesive layer) 30 has been omitted. The second region 14 of the first layer 10 was a substantially circular shape (diameter: about 100 μm). An area ratio (designed value) occupied by the second region 14 in the first layer 10 was 19.6%.

### Reference Example

An optical member disclosed in WO 2022/071165 A1 filed by the applicant of the present application was produced as described below.

### (1) Configuration of Optical Member

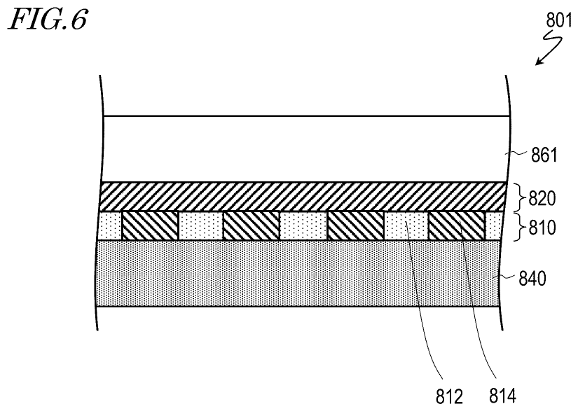

The configuration of the optical member 801 of Reference Example is illustrated in FIG. 6. The optical member 801 illustrated in FIG. 6 includes: a first layer 810 having a porous structure; and a second layer 820 adjacent to the first layer 810 in a layer normal direction. The second layer 820 contains a resin composition, and its transmittance for light (near-infrared light) having a wavelength in the range of from more than 800 nm to 2,000 nm or less is 5% or more and 85% or less. The first layer 810 includes: a first region 812 having the porous structure; and a second region 814 obtained by the filling of the resin composition into each of the pores of the porous structure. The second layer 820 has an adhesive property. The optical member 801 further includes: a substrate layer 840 supporting the first layer 810; and a peeling sheet 861 arranged on the side of the second layer 820 opposite to the first layer 810.

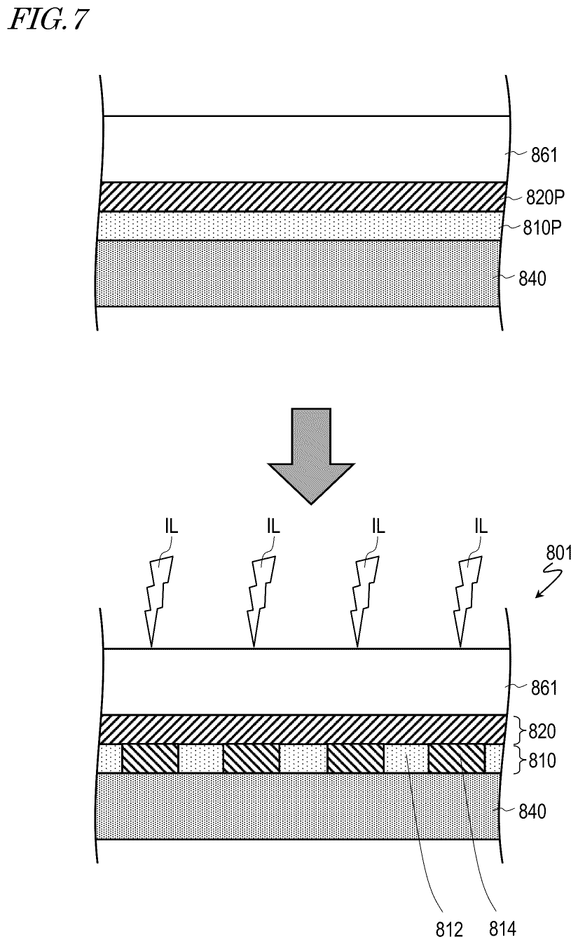

When the optical member 801 is produced, first, as illustrated in the upper section of FIG. 7, a laminate in which a porous layer 810P having a porous structure, the layer serving as the first layer 810, an infrared light-absorbing resin composition layer 820P serving as the second layer 820 and the peeling sheet 861 are laminated on the substrate layer 840 is prepared. The laminate is obtained by, for example, superimposing the following laminates on each other: a first laminate in which the porous layer 810P is formed on the substrate layer 840; and a second laminate in which the infrared light-absorbing resin composition layer 820P is formed on the peeling sheet 861. Next, as illustrated in the lower section of FIG. 7, the partial region of the infrared light-absorbing resin composition layer 820P is selectively irradiated with near-infrared light IL. The infrared light-absorbing resin composition layer 820P absorbs the near-infrared light IL. Accordingly, the resin composition in the region irradiated with the near-infrared light IL is melted, and hence the resin composition is selectively filled into a pore of the porous structure of the porous layer 810P. As a result, the first region 812 that is not filled with the resin composition has a refractive index smaller than that of the second region 814 obtained by the filling of the resin composition into each of the pores of the porous structure.

### (2) Production of First Laminate

A coating liquid for forming a porous layer (the first region 812 of the first layer 810) was prepared in the same manner as in Example 1. The resultant coating liquid was applied to the surface of an acrylic resin film (thickness: 40 μm) prepared in accordance with Production Example 1 of Japanese Patent Application Laid-open No. 2012-234163 to form a coating film. The coating film was dried at 100° C. for 1 minute, and the coating film after the drying was irradiated with UV light having a wavelength of 360 nm in a light irradiation amount (energy) of 300 mJ/cm². Thus, the first laminate (acrylic film with a silica porous layer) in which the porous layer (silica porous body obtained by chemical bonding between silica microporous particles) 810P was formed on the acrylic resin film (the substrate layer 840) was obtained. The refractive index of the porous layer 10P was 1.15.

### (3) Production of Second Laminate

A laminated structure of a tacky layer (resin composition layer) free of a pigment and a pigment layer formed on the tacky layer was used as the infrared light-absorbing resin composition layer 820P. 0.2 Part by mass of a dye-based pigment CIR-RL (phenylenediamine-based diimmonium compound) manufactured by Japan Carlit Co., Ltd. was added to 100 parts by mass of a solvent (MIBK/EtOH/H₂O, mass ratio: 1:9:1) to prepare a pigment solution.

One separator of a double-sided tackiness agent A (PET separator/acrylic tackiness agent A/PET separator, thickness: 38 μm/10 μm/38 μm) produced by a method disclosed in paragraphs to of WO 2022/071165 A1 was peeled, and the above-mentioned pigment solution was applied to the surface of the exposed acrylic tackiness agent to form a film having a wet thickness of 33 μm. The resultant was loaded into a heating oven set to 100° C. and dried for 2 minutes. Thus, the pigment layer was obtained. The transmittance of the laminate of the optical tacky layer and the pigment layer for laser light having a wavelength of 1,064 nm was 49%.

### (4) Production of Optical Member and Optical Element

The second laminate was bonded to the main surface of the porous layer 810P of the first laminate, and the resultant was cut into an outer shape having a size of 100 mm to provide a test piece for producing an optical member.

The resultant test piece was fixed to a vacuum adsorption stage, and under the state, the test piece was irradiated with near-infrared laser light under the following various conditions to produce the optical member 801.

Laser oscillator: JenLas fiber ns20 manufactured by Jenoptik AG

Wavelength: 1,064 nm

Objective lens: fe lens (£82 mm)

Scanner: intelliSCAN 14 (galvano scanner) manufactured by SCANLAB GmbH

Beam intensity distribution: Gaussian

Spot size: q60 μm

Repetition frequency: 12.5 kHz

Scan rate: 2.5 m/s

Pattern pitch: 200 μm

Pattern processing area: 7100 mm

Power: 5.6 W

Pulse energy: 448 μJ

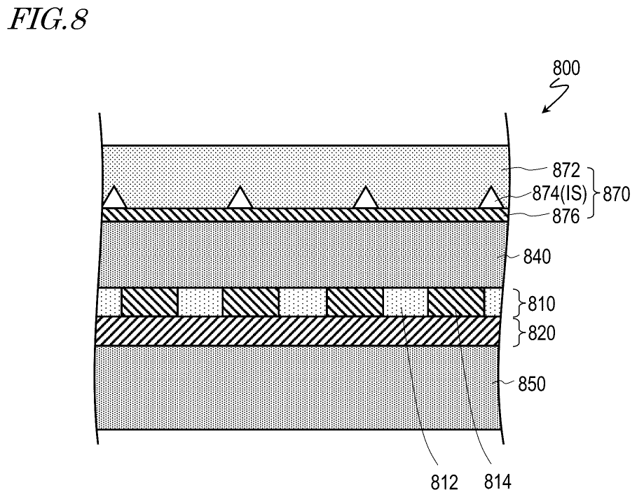

The optical element 800 illustrated in FIG. 8 was produced by using the resultant optical member 801. The optical element 800 was produced by: peeling the peeling sheet 861 of the optical member 801; bonding a light-guiding layer 850 to the second layer 820; and arranging a direction-changing layer 870 including a plurality of internal spaces IS to the side of the substrate layer 840 opposite to the first layer 810 (specifically, bonding a shaping film 872 to the substrate layer 840 via an adhesive layer 876). The adhesive layer 876 was formed by using a polyester-based adhesive. The shaping film 872 having a plurality of recesses 874 was produced in the same manner as in the shaping film 72 used in Example 1. The second region 814 of the first layer 810 was a substantially circular shape (diameter: about 50 μm). An area ratio (designed value) occupied by the second region 814 in the first layer 810 was 4.9%.

### COMPARATIVE EXAMPLE

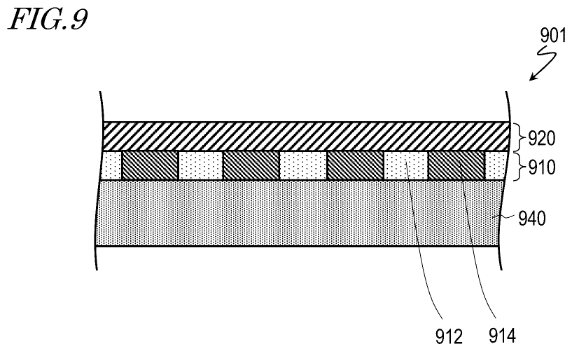

An optical member 901 illustrated in FIG. 9 was produced by using an inkjet method as disclosed in Patent Document No. 1.

### (1) Configuration of Optical Member

The optical member 901 illustrated in FIG. 9 includes: a first layer 910 having a porous structure; a second layer 920 adjacent to the first layer 910 in a layer normal direction; and a substrate layer 940 supporting the first layer 910.

The first layer 910 includes: a first region 912 having the porous structure; and a second region 914 obtained by the filling of the resin composition into each of the pores of the porous structure. The second layer 920 is a layer containing the resin composition, and is more specifically a pressure-sensitive adhesive layer.

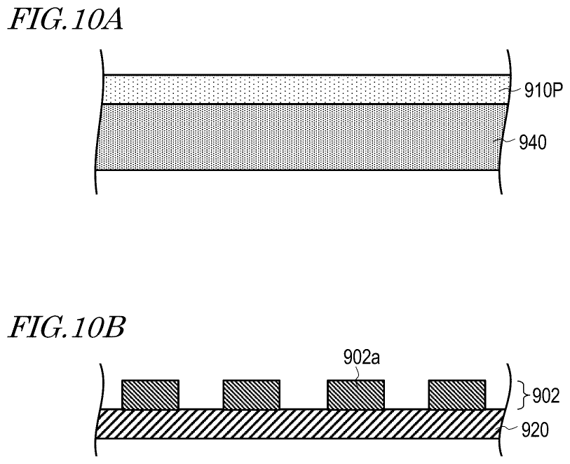

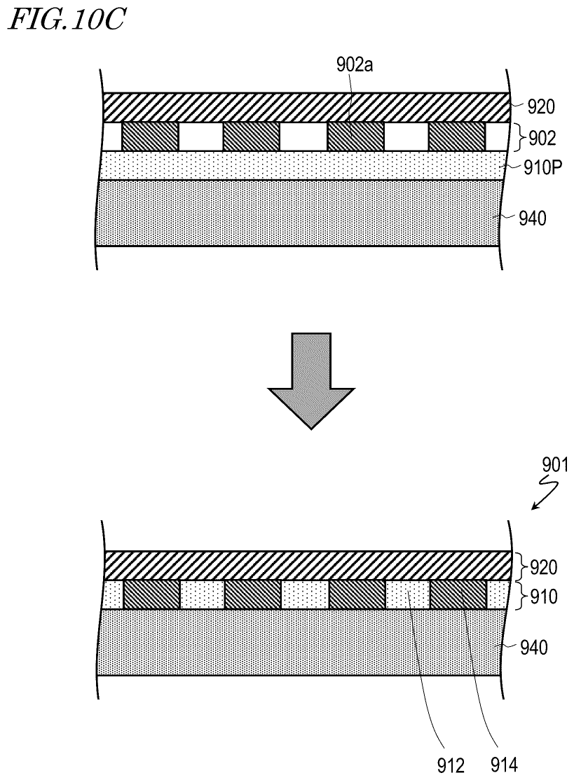

When the optical member 901 is produced, first, as illustrated in FIG. 10A, a first laminate in which a porous layer 910P having a porous structure, the layer serving as the first layer 910, is formed on the substrate layer 940 is prepared. In addition, as illustrated in FIG. 10B, a second laminate in which a resin pattern layer 902 including a plurality of discrete island-like regions 902a is formed on the second layer (pressure-sensitive adhesive layer) 920 through use of a photocurable resin composition by the inkjet method is prepared.

Next, as illustrated in the upper section of FIG. 10c, the first laminate and the second laminate are superimposed on each other so that the resin pattern layer 902 may be adjacent to the porous layer 910P. Subsequently, as illustrated in the lower section of FIG. 10C, the photocurable resin composition of the resin pattern layer 902 is caused to permeate into the pores of the porous layer 910P, and is photocured. Thus, the optical member 901 including the first layer 910 in which the first region 912 that is not filled with the resin composition and the second region 914 obtained by the filling of the resin composition into each of the pores of the porous structure are arranged in a predetermined pattern is obtained.

### (2) Production of First Laminate

The first laminate (acrylic film with a silica porous layer) in which the porous layer 910P was formed on an acrylic resin film serving as the substrate layer 940 was obtained in the same manner as in Reference Example.

### (3) Production of Second Laminate

The pressure-sensitive adhesive layer 920 was formed on a PET film subjected to release treatment by using an acrylic pressure-sensitive adhesive. The pressure-sensitive adhesive layer 920 had a thickness of 10 μm and a refractive index of 1.47. The mixed liquid of epoxy-based monomers adjusted to a concentration of 25% was dropped as ink onto the pressure-sensitive adhesive layer 920 with an inkjet apparatus manufactured by Cluster Technology Co., Ltd. (product name: PIJIL-HV) at the same pattern pitch as that of each of Examples 1 to 5. Thus, the resin pattern layer 902 was formed.

### (4) Production of Optical Member and Optical Element

The first laminate and the second laminate were superimposed on each other so that the resin pattern layer 902 was adjacent to the porous layer 910P. The photocurable resin composition of the resin pattern layer 902 was caused to permeate into the pores of the porous layer 10P. Next, the resultant laminate was irradiated with UV light from its first laminate side in an irradiation amount of 600 mJ, and was subsequently stored in a dryer at 60° C. for 20 hours.

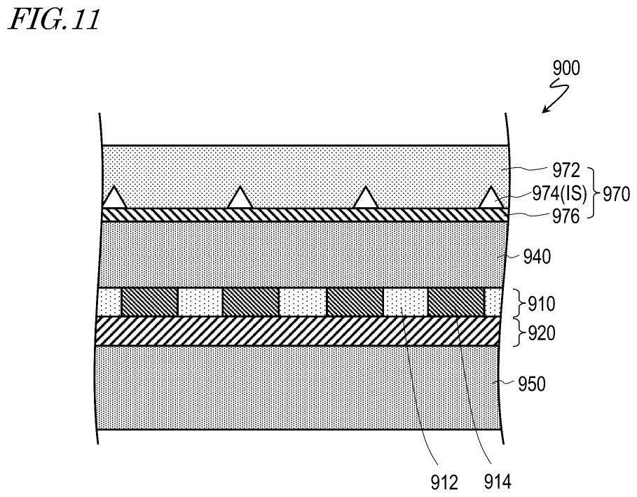

The optical element 900 illustrated in FIG. 11 was produced by using the resultant optical member 901. The optical element 900 was produced by: peeling the PET film of the optical member 901; bonding a light-guiding layer 950 to the second layer 920; and arranging a direction-changing layer 970 including a plurality of internal spaces IS to the side of the substrate layer 940 opposite to the first layer 910 (specifically, bonding a shaping film 972 to the substrate layer 940 via an adhesive layer 976). The adhesive layer 976 was formed by using a polyester-based adhesive. The shaping film 972 having a plurality of recesses 974 was produced in the same manner as in the shaping film 72 used in Example 1. The second region 914 of the first layer 910 was a substantially circular shape (diameter: about 66 μm). An area ratio (designed value) occupied by the second region 914 in the first layer 910 was 8.6%.

### [Evaluation of Light Distribution Characteristic]

The optical elements of Examples 1 to 6, Reference Example and Comparative Example were evaluated for their light distribution characteristics. An LED light source was arranged in an end portion of the light-guiding layer of each of the optical elements. Light was caused to enter the optical element from the end portion of the light-guiding layer, and the light was taken out of the shaping film side of the element. The brightness distribution (relationship between the light emission angle and brightness) of the light that had been taken out was measured with an imaging colorimeter (ProMetric I-Plus manufactured by Radiant Vision Systems, LLC). The size of a measurement area was a 35-millimeter square (equal to the size of a detector lens). A peak angle and a half-value angle were calculated from the measured brightness distribution. The peak angle is the angle at which the brightness becomes maximum, and hence the angle can be said to be an indicator of the fact that the light can be taken out in a front direction. The half-value angle (full width at half maximum) is an angle range in which the brightness reduces from the maximum to one half of the maximum, and hence the angle can be said to be an indicator of the extent to which the light that has been taken out spreads.

The evaluation results are shown in Table 1. In the column “Evaluation of light distribution characteristic” in Table 1, a case in which the peak angle is within +15° and the half-value angle is 35° or less is regarded as “OK”, and any other case is regarded as “NG”.

TABLE 1

| | | | Evaluation of light |
|---|---|---|---|
| | Peak angle | Half-value | distribution |
| | [°] | angle [°] | characteristic |
| Example 1 | −10 | 27 | OK |
| Example 2 | −11 | 34 | OK |
| Example 3 | −11 | 25 | OK |
| Example 4 | −12 | 31 | OK |
| Example 5 | −6 | 33 | OK |
| Example 6 | −4 | 29 | OK |
| Reference | 17 | 46 | NG |
| Example | | | |
| Comparative | 20 | 52 | NG |
| Example | | | |

As can be seen from Table 1, it was recognized that in each of Examples 1 to 6, the peak angle was within +15° and the half-value angle was 35° or less, and hence light having high directivity was able to be taken out in the front direction. In contrast, in each of Reference Example and Comparative Example, the peak angle was not within 115° and the half-value angle was more than 35°.

As described above, it was recognized that according to the production method according to the embodiment of the present invention, an optical member including a light-coupling layer (light-extracting layer) capable of taking out light having sufficiently high directivity was obtained. The reason why the directivity of the light to be taken out can be improved by the embodiment of the present invention is assumed to be as described below.

In the optical member 801 of Reference Example, the porous structure and the resin composition are mixed in the second region 814 of the first layer 810. In addition, also in the optical member 901 of Comparative Example, the porous structure and the resin composition are mixed in the second region 914 of the first layer 910. In contrast, in the optical member 1 obtained by the production method according to the embodiment of the present invention, the second region 14 of the first layer 10 is free of a porous structure, and substantially only the adhesive is present in the second region 14. It is conceivable that scattering (diffusion) around the second region 14 was suppressed by the foregoing, and the suppression contributed to the improvement in directivity.

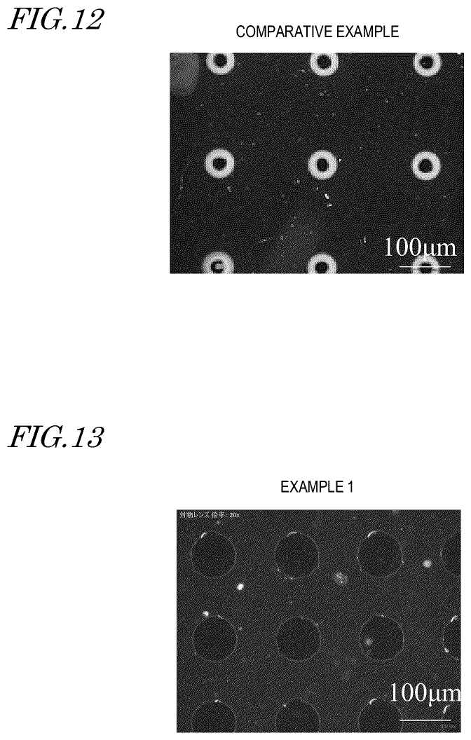

An optical microscope image of the optical member of Comparative Example is shown in FIG. 12, and an optical microscope image of the optical member of Example 1 is shown in FIG. 13. As shown in each of FIG. 12 and FIG. 13, a white portion caused by light scattering is present around the second region that is substantially close to a circular shape. The area of the above-mentioned white portion is preferably as small as possible because the light scattering may make it impossible to obtain a desired light distribution characteristic. Comparison between FIG. 12 and FIG. 13 shows that in Example 1, the area of the white portion is smaller than that in Comparative Example, and hence the scattering around the second region is suppressed.

As described above, the fracture of the porous layer 10P may occur in the step of applying the laser light to the porous layer 10P. Herein, such phenomenon is more specifically described.

The inventors of the present application have investigated various conditions for the production method according to the embodiment of the present invention, and as a result, have found that at the time of the partial removal of the porous layer 10P by a laser lift-off method, a fracture may occur in the remaining porous layer 10P.

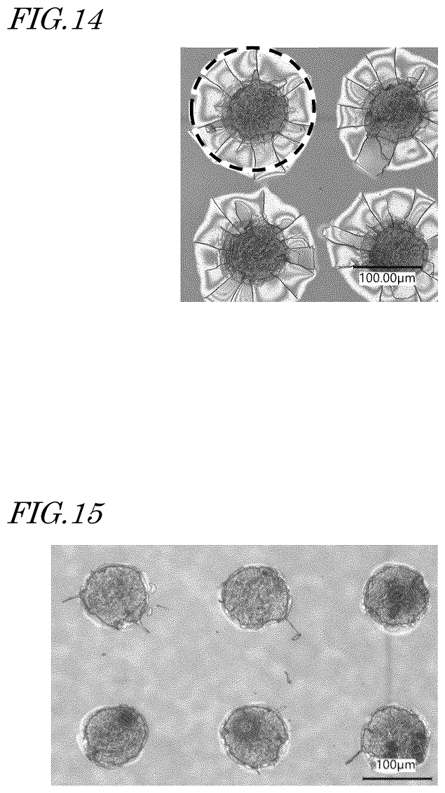

An optical microscope image of the optical member in which the fracture of the porous layer 10P occurs is shown in FIG. 14, and an optical microscope image of the optical member in which the fracture of the porous layer 10P does not occur is shown in FIG. 15. In the example shown in FIG. 14, a radial crack occurs around the second region 14 that is substantially close to a circular shape. In contrast, in the example shown in FIG. 15, such crack does not occur around the second region 14. The fracture of the porous layer 10P may be responsible for a reduction in appearance of the optical member or light directivity.

The inventors of the present application have made a more detailed investigation, and as a result, have found that the ease with which the fracture of the porous layer 10P occurs correlates with the thickness of the peeling layer 2. Specifically, the inventors have found that as the peeling layer 2 becomes thicker, the fracture of the porous layer 10P more easily occurs (conversely, as the peeling layer 2 becomes thinner, the fracture of the porous layer 10P less easily occurs).

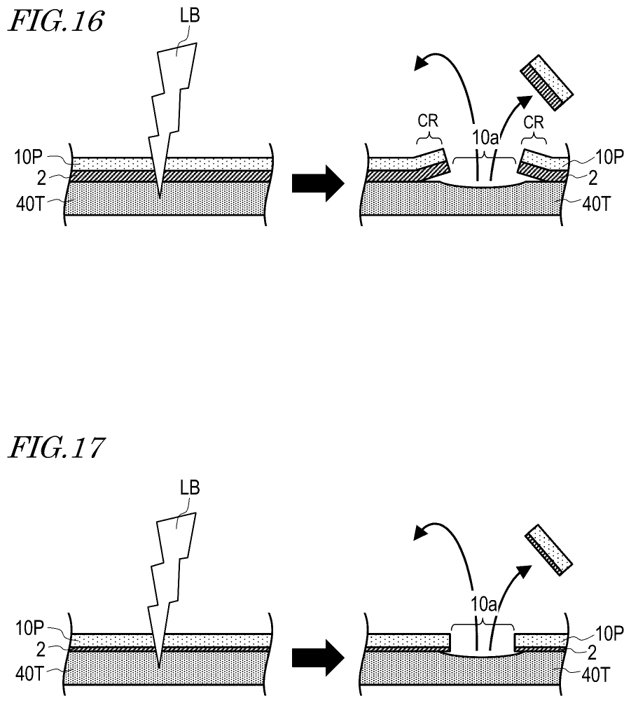

A principle for the occurrence of the fracture of the porous layer 10P is assumed to be as described below. FIG. 16 and FIG. 17 are each a view for describing the principle for the occurrence of the fracture of the porous layer 10P, and are each an illustration of a manner in which part of the porous layer 10P is peeled by the application of the laser light LB together with the peeling layer 2. FIG. 16 is an illustration of a case in which the peeling layer 2 is relatively thick, and FIG. 17 is an illustration of a case in which the peeling layer 2 is relatively thin.

When the porous layer 10P is partially removed by the laser lift-off method, the substrate 40T reacts with the laser light LB to explode near its interface with the peeling layer 2, and the peeling layer 2 and the porous layer 10P are physically removed by the momentum of the explosion.

When the peeling layer 2 is relatively thick, as illustrated in FIG. 16, the momentum of the explosion of the substrate 40T may not suffice for the peeling of the peeling layer 2, and hence a region CR where the peeling layer 2 and the porous layer 10P start to peel (lift from the substrate 40T) may be formed around the region (island-like region 10a) from which the porous layer 10P has been removed. The fracture of the porous layer 10P occurs in such region CR.

In contrast, when the peeling layer 2 is relatively thin, as illustrated in FIG. 17, the momentum of the explosion of the substrate 40T often suffices for the peeling of the peeling layer 2, and hence the region CR where the peeling layer 2 and the porous layer 10P start to peel (lift from the substrate 40T) is hardly formed around the region (island-like region 10a) from which the porous layer 10P has been removed. Accordingly, the fracture of the porous layer 10P hardly occurs.

When the thickness of the peeling layer 2 is set to be relatively small as described above, the fracture of the porous layer 10P can be suppressed. As described above, the thickness of the peeling layer 2 is preferably 500 nm or less, more preferably 250 nm or less, still more preferably 200 nm or less.

Herein, the result of the verification of the ease with which the fracture of the porous layer 10P occurs is described by way of Examples 7 to 9 in addition to Examples 1, 2 and 4 described above.

### EXAMPLE 7

The peeling layer 2 having a thickness of 144 nm was formed in the same manner as in Example 1 except that: a PEN film having a thickness of 50 μm (Q51 manufactured by Toyobo Co., Ltd.) was prepared as the substrate 40T; and ZEONEX T62R manufactured by Zeon Corporation was used as a COP thereon. The porous layer 10P was formed on the peeling layer 2 in the same manner as in Example 1, and UV laser light was applied to the resultant laminate under the following various conditions to remove the partial region (plurality of island-like regions) of the porous layer 10P. An optical element was produced in the same manner as in Example 1 by using the laminate from which the porous layer 10P had been partially removed as described above. The second region 14 of the first layer 10 was a substantially circular shape (diameter: about 93 μm). An area ratio (designed value) occupied by the second region 14 in the first layer 10 was 17.0%.

Laser oscillator: Talon 355-20 manufactured by Spectra-Physics, Inc.

Wavelength: 355 nm

Scanner: intelliSCAN 14 (galvano scanner) manufactured by SCANLAB GmbH

Beam intensity distribution: Gaussian

Focal spot size: 980 μm

Repetition frequency: 50 KHz

Pattern pitch: 200 μm

Power: 2.0 W

Pulse energy: 40 μJ

### EXAMPLE 8

An optical element was produced in the same manner as in Example 7 except that the thickness of the peeling layer 2 was 414 nm. The second region 14 of the first layer 10 was a substantially circular shape (diameter: about 91 μm). An area ratio (designed value) occupied by the second region 14 in the first layer 10 was 16.3%.

### EXAMPLE 9

An optical element was produced in the same manner as in Example 7 except that the thickness of the peeling layer 2 was 583 nm. The second region 14 of the first layer 10 was a substantially circular shape (diameter: about 97 μm). An area ratio (designed value) occupied by the second region 14 in the first layer 10 was 18.5%.

### [Evaluation of Fracture of Porous Layer 10P]

The optical elements of Examples 1, 2, 4 and 7 to 9 were each evaluated for the fracture of the porous layer 10P. The fracture evaluation was performed by measuring the width of a region (region whose outer shape was indicated by a dotted line in FIG. 14) where the fracture of the porous layer 10P occurred in an optical microscope image. A case in which the width of the region where the fracture occurred was less than 30 μm, a case in which the width was 30 μm or more and less than 50 μm, a case in which the width was 50 μm or more and less than 100 μm and a case in which the width was 100 μm or more were evaluated as “A”, “B”, “C” and “D”, respectively.

The results of the evaluation of the fracture of the porous layer 10P are shown in Table 2. The absorption coefficient of the substrate 40T and the thickness of the peeling layer 2 in each example are also shown in Table 2.

TABLE 2

| | | | Evaluation of fracture of porous |
|---|---|---|---|
| | | | layer |
| | | | A: less than 30 μm |
| | Absorption | Thickness | B: 30 μm or more and less than |
| | coefficient | of | 50 μm |
| | of | peeling | C: 50 μm or more and less than |
| | substrate | layer | 100 μm |
| | [cm⁻¹] | [nm] | D: 100 μm or more |
| Example 1 | 596 | 230 | B |
| Example 2 | 9,247 | None | B |
| Example 4 | 228 | 230 | B |
| Example 7 | 1,257 | 144 | A |
| Example 8 | 1,257 | 414 | B |
| Example 9 | 1,257 | 583 | C |

As can be seen from Table 2, with regard to the fracture of the porous layer 10P, the results of the evaluations (“B”) of Examples 1, 2, 4 and 8 were higher than the result of the evaluation (“C”) of Example 9, and the result of the evaluation (“A”) of Example 7 was even higher. It was recognized that as the thickness of the peeling layer 2 became smaller as described above, the fracture of the porous layer 10P was suppressed to a larger extent. In addition, in Example 1, a pattern of circles each having a diameter of about 93 μm is processed by inputting an energy of 73 μJ. In contrast, in each of Example 7, 8 and 9, a pattern of circles each having a diameter of about 90 μm can be processed by inputting an energy of 40 μJ. It was recognized that when the absorption coefficient of the substrate 40T for the UV laser light was 1,000 cm⁻¹ or more as described above, processing efficiency was improved.

Next, an example of a constituent to be suitably used in the optical element according to the embodiment of the present invention is described.

### [Light-guiding Layer]

A publicly-known light-guiding layer (light-guiding body) may be widely used as the light-guiding layer 50. The light-guiding layer 50 may typically include a film or plate-like product of a resin (preferably a transparent resin). The resin may be a thermoplastic resin or a photocurable resin. The thermoplastic resin is, for example, a (meth)acrylic resin, such as polymethyl methacrylate (PMMA) or polyacrylonitrile, a polycarbonate (PC) resin, a polyester resin such as PET, a cellulose-based resin such as triacetyl cellulose (TAC), a cyclic polyolefin-based resin or a polystyrene-based resin. For example, a photocurable resin, such as an epoxy acrylate-based resin or a urethane acrylate-based resin, is suitably used as the photocurable resin. Those resins may be used alone or in combination thereof.

The thickness of the light-guiding layer 50 may be, for example, 100 μm or more and 100 mm or less. The thickness of the light-guiding layer 50 is preferably 50 mm or less, more preferably 30 mm or less, still more preferably 10 mm or less.

The value of the ratio of the refractive index nGP of the light-guiding layer 50 to, for example, the refractive index n₃ of the second layer 20 falls within the range of from −0.1 to +0.1, and the lower limit value of the nGp is preferably 1.43 or more, more preferably 1.47 or more. Meanwhile, the upper limit value of the refractive index of the light-guiding layer 50 is 1.7.

Although a conventional light-guiding layer having an uneven shape on its surface may be used as the light-guiding layer 50, a light-guiding layer whose surface is substantially flat like the light-guiding layer 50 illustrated in FIG. 1 may be suitably used. The optical member 1 that functions as a light-coupling layer may have a substantially flat main surface, and hence can be easily laminated together with the light-guiding layer 50 having a substantially flat surface. In addition, the member can be easily laminated together with any other optical component having a substantially flat surface. The term “substantially flat surface” means that the uneven shape of the surface neither refracts nor diffuses and reflects light.

### [Porous Layer and First Region of First Layer]

The first region 12 of the first layer 10 has a porous structure. The first layer 10 may be formed from the porous layer 10P. The porous layer 10P to be suitably used contains, for example, substantially spherical particles, such as silica particles, silica particles having micropores or silica hollow nanoparticles, fibrous particles, such as cellulose nanofibers, alumina nanofibers or silica nanofibers, or flat plate-like particles such as nanoclay formed from bentonite. In one embodiment, the porous layer 10P is a porous body formed by direct chemical bonding between particles (e.g., microporous particles). In addition, at least part of the particles for forming the porous layer 10P may be bonded to each other through a small amount (e.g., equal to or less than the mass of the particles) of a binder component. The porosity and refractive index of the porous layer 10P may be adjusted by, for example, the particle diameters and particle diameter distribution of the particles for forming the porous layer 10P.

Examples of a method of obtaining the porous layer 10P include: a method of forming a low-refractive index layer described in WO 2019/146628 A1; and methods described in Japanese Patent Application Laid-open No. 2010-189212, Japanese Patent Application Laid-open No. 2008-040171, Japanese Patent Application Laid-open No. 2006-011175, WO 2004/113966 A1, Japanese Patent Application Laid-open No. 2017-054111, Japanese Patent Application Laid-open No. 2018-123233 and Japanese Patent Application Laid-open No. 2018-123299, and references thereof. All the contents disclosed in those publications are incorporated herein by reference.

A silica porous body may be suitably used as the porous layer 10P. The silica porous body is produced by, for example, any one of the following methods: a method including subjecting at least one of a silicon compound, a hydrolyzable silane and/or a silsesquioxane, and a partial hydrolysate and a dehydration condensate thereof to hydrolysis and polycondensation; a method including using porous particles and/or hollow fine particles; a method including producing an aerogel layer through utilization of a spring-back phenomenon; and a method including using pulverized gel, which is obtained by pulverizing a gel-like silicon compound obtained by a sol-gel method and chemically bonding microporous particles that are the resultant pulverized bodies to each other with a catalyst or the like. However, the porous layer 10P is not limited to the silica porous body, and the production method therefor is also not limited to the listed production methods. The layer may be produced by any production method. The silsesquioxane is a silicon compound using RSiO_{1.5} (where R represents a hydrocarbon group) as a basic constituent unit, and is strictly different from silica using SiO₂ as a basic constituent unit. However, the silsesquioxane and silica have the following in common: the silsesquioxane and silica each have a network structure crosslinked by a siloxane bond. Accordingly, herein, a porous body including the silsesquioxane as a basic constituent unit is also referred to as “silica porous body” or “silica-based porous body.”

The silica porous body may include the microporous particles of a gel-like silicon compound bonded to each other. The microporous particles of the gel-like silicon compound are, for example, the pulverized bodies of the gel-like silicon compound. The silica porous body may be formed by, for example, applying a coating liquid containing the pulverized bodies of the gel-like silicon compound to a substrate. The pulverized bodies of the gel-like silicon compound may be chemically bonded (e.g., a siloxane bond) to each other by, for example, a catalytic action, photoirradiation or heating.

The lower limit value of the thickness of the porous layer 10P (first layer 10) only needs to be larger than, for example, the wavelength of light to be used. Specifically, the lower limit value is, for example, 0.3 μm or more. Although the upper limit value of the thickness of the first layer 10 is not particularly limited, the upper limit value is, for example, preferably 5 μm or less, more preferably 3 μm or less. When the thickness of the first layer 10 falls within the above-mentioned ranges, the unevenness of its surface does not become so large as to affect lamination, and hence the layer is easily composited or laminated with any other member.

The refractive index of the porous layer 10P, that is, the refractive index n₁ of the first region 12 of the first layer 10 is preferably 1.30 or less. Total internal reflection easily occurs at an interface in contact with the first region 12, that is, a critical angle can be reduced. The refractive index m₁ of the first region 12 is more preferably 1.25 or less, still more preferably 1.18 or less, particularly preferably 1.15 or less. Although the lower limit of the refractive index mi of the first region 12 is not particularly limited, the lower limit is preferably 1.05 or more from the viewpoint of mechanical strength.

The lower limit value of the porosity of the porous layer 10P, that is, the porosity of the first region 12 of the first layer 10 is, for example, 40% or more, preferably 50% or more, more preferably 55% or more, more preferably 70% or more. The upper limit value of the porosity of the porous layer 10P is, for example, preferably 90% or less, more preferably 85% or less. When the porosity falls within the above-mentioned ranges, the refractive index of the first region 12 can be set within an appropriate range. The porosity of the layer may be calculated from the value of the refractive index thereof measured with, for example, an ellipsometer by Lorentz-Lorenz's formula.

The film density of the porous layer 10P, that is, the film density of the first region 12 of the first layer 10 is, for example, 1 g/cm³ or more, preferably 10 g/cm³ or more, more preferably 15 g/cm³ or more. Meanwhile, the film density is, for example, 50 g/cm³ or less, preferably 40 g/cm³ or less, more preferably 30 g/cm³ or less, still more preferably 2.1 g/cm³ or less. The range of the film density is, for example, 5 g/cm³ or more and 50 g/cm³ or less, preferably 10 g/cm³ or more and 40 g/cm³ or less, more preferably 15 g/cm³ or more and 30 g/cm³ or less. Alternatively, the range is, for example, 1 g/cm³ or more and 2.1 g/cm³ or less. The film density may be measured by a publicly-known method.

When the refractive index of a material for forming the matrix portion of the porous layer 10P (portion except the pores of the porous layer 10P) is represented by n_{M}, the refractive index of the porous layer 10P, that is, the refractive index n₁ of the first region 12 is determined by the n_{M}, the porosity of the layer and the refractive index of air. For example, when a silica porous body is used as the porous layer 10P as described above, the n_{M} is, for example, 1.41 or more and 1.43 or less.

[Second Region of First Layer]

The second region 14 of the first layer 10 is formed by filling the adhesive into the region from which the porous layer 10P has been removed. The refractive index n₂ of the second region 14 satisfies the relationships of n₁<n₂ and n₁<n₃ together with the refractive index n₁ of the first region 12 and the refractive index n₃ of the second layer 20. When the refractive index n₂ of the second region 14 satisfies the relationships, light scattering reflection and refraction at an interface between the first region 12 and the second region 14 in the surface direction of the first layer 10 can be suppressed. The lower limit value of the refractive index n₂ of the second region 14 is, for example, more than 1.30, preferably 1.35 or more, more preferably 1.40 or more.

When the adhesives are filled from both the second layer 20 and the third layer 30 into the region 10a from which the porous layer 10P has been removed, the second region 14 has a structure in which a region including the adhesive from the second layer 20 and a region including the adhesive from the third layer 30 are laminated along a thickness direction. A difference between the refractive index n₃ of the second layer 20 and the refractive index n₄ of the third layer 30 is preferably as small as possible from the viewpoint of suppressing reflection, refraction or the like at an interface between the former region and the latter region. Specifically, the difference between the refractive index n₃ of the second layer 20 and the refractive index n₄ of the third layer 30 is preferably 0.05 or less, more preferably 0.03 or less, still more preferably 0.02 or less.

### [Base Material Layer]

The thickness of the substrate layer 40 is, for example, 1 μm or more and 1,000 μm or less, preferably 10 μm or more and 100 μm or less, more preferably 20 μm or more and 80 μm or less. The refractive index of the substrate layer 40 is preferably 1.40 or more and 1.70 or less, more preferably 1.43 or more and 1.65 or less.

### [Adhesive Layer]

The thicknesses of the first adhesive layer 20, the second adhesive layer 30 and the adhesive layer 76 are each independently, for example, 0.1 μm or more and 100 μm or less, preferably 0.3 μm or more and 100 μm or less, more preferably 0.5 μm or more and 50 μm or less. The refractive indices of the first adhesive layer 20, the second adhesive layer 30 and the adhesive layer 76 are each independently preferably 1.42 or more and 1.60 or less, more preferably 1.47 or more and 1.58 or less. In addition, the refractive indices of the first adhesive layer 20, the second adhesive layer 30 and the adhesive layer 76 are preferably close to the refractive indices of the light-guiding layer 50, the substrate layer 40 and the shaping film 72 in contact therewith, respectively, and the absolute value of a difference in refractive index between the layers in contact with each other is preferably 0.2 or less.

### INDUSTRIAL APPLICABILITY

The optical member obtained by the production method according to the embodiment of the present invention is turned into an optical element (light-guiding element) together with, for example, a light-guiding layer, and is applicable to, for example, public or general lighting, such as a front light, a back light, lighting for a window or a facade, signage, a signal light, window lighting, wall surface lighting, table lighting, a solar application, a decorative illumination, a light shield, a light mask or roof lighting. In addition, the optical member obtained by the production method according to the embodiment of the present invention is suitably used as a constituent member for the front light of a reflection-type display serving as an example of the signage. When the optical member obtained by the production method according to the embodiment of the present invention is used, an image or a graphic on the reflection-type display, which is free of an optical defect such as a viewable blur caused by scattered or diffracted light, can be viewed.

### REFERENCE SIGNS LIST

1 optical member
10 first layer
12 first region
14 second region
20 second layer (first adhesive layer)
30 third layer (second adhesive layer)
40 substrate layer
50 light-guiding layer
70 direction-changing layer
72 shaping film
74 recess
76 adhesive layer
100 optical element
IS internal space

1. An optical member production method comprising:
preparing a porous layer supported on a substrate;
applying laser light to the porous layer to remove a partial region of the porous layer, the partial region to be removed including a plurality of discrete island-like regions; and
arranging a first adhesive layer on the porous layer after applying laser light.

2. The optical member production method of claim 1, further comprising:
peeling the substrate from the porous layer after arranging the first adhesive layer; and
arranging a second adhesive layer on a side of the porous layer opposite to the first adhesive layer after peeling the substrate.

3. The optical member production method of claim 1, wherein an absorption coefficient of the substrate for the laser light is 500 cm⁻¹ or more.

4. The optical member production method of claim 1, wherein a light intensity distribution of the laser light is a top-hat type.

5. The optical member production method of claim 1, wherein the laser light is UV laser light.

6. The optical member production method of claim 5, wherein an absorption coefficient of the substrate for the UV laser light is 1,000 cm⁻¹ or more.

7. The optical member production method of claim 1, wherein in preparing the porous layer supported on the substrate, the porous layer is formed on a peeling layer arranged on the substrate.

8. The optical member production method of claim 7, wherein the peeling layer contains, as a main component, a polymer free of a polar group.

9. The optical member production method of claim 7, wherein the peeling layer is formed from a cycloolefin-based polymer.

10. The optical member production method of claim 9, wherein the peeling layer has a thickness of 500 nm or less.
